(19) United States
(12) Patent Application Publication
(10) Pub. No.: US 2024/0242463 A1
(43) Pub. Date: Jul. 18, 2024

(54) INFORMATION PROCESSING SYSTEM FOR DETECTION USING INDIVIDUAL SEPARATED COMPARTMENT

(71) Applicant: CANON KABUSHIKI KAISHA, Tokyo (JP)

(72) Inventor: SOTA TORII, Tokyo (JP)

(21) Appl. No.: 18/414,938

(22) Filed: Jan. 17, 2024

(30) Foreign Application Priority Data
Jan. 17, 2023 (JP) 2023-005486

(51) Int. Cl. G06V 10/25; G06V 10/60

(52) U.S. Cl. CPC G06V 10/25; G06V 10/60; G06V 2201/07

(57) ABSTRACT

An information processing system using an individual separated compartment for detecting a target through use of the individual separated compartment, the information processing system including: an image acquisition unit configured to acquire an image including, as an object, a plurality of individual separated compartments in which a target is includable, an exclusion region determination unit configured to set, based on the image, a characteristic value for determining an exclusion region to be excluded from among a plurality of regions of the image, and determine the exclusion region based on the characteristic value of the plurality of regions, and a calculation unit configured to calculate information relating to the target from an image of individual separated compartments included in each region for calculation obtained by excluding the exclusion region from the image.

### BACKGROUND

### Field of the Disclosure

The present disclosure relates to an information processing system for detection using an individual separated compartment, a detection apparatus, a detection method, and a program to be used for the detection method.

### Description of the Related Art

Jennifer Doudna et al. at the University of California have shown that different strains of human papilloma virus (HPV) in a human sample can be accurately detected in distinction from each other through use of Casl2a (Science 27 Apr. 2018: Vol. 360, Issue 6387, pp. 436-439). A complex composed of Casl2a and crRNA specifically recognizes a sequence of target DNA and is bound thereto, and Casl2a cleaves the bound target DNA. In that case, when a reporter molecule in which a fluorescent substance and a quencher are linked to each other by single-stranded DNA is added to a reaction system, Casl2a cleaves the single-stranded DNA of the reporter molecule by a trans-cleavage reaction. Thus, the fluorescent substance and the quencher are separated, and fluorescence is generated. That is, when the target DNA is present in the sample, fluorescence is generated from the fluorescent substance derived from the reporter molecule through activation of the trans-cleavage reaction of Casl2a, and hence the target DNA can be detected based on the fluorescence. In recent years, as in Japanese Patent Application Laid-Open No. 2020-172561, there have been developed methods in which such a detection reagent is fed into individual separated compartments, isolated by a hydrophobic solvent, and detected by a fluorescence microscope or the like.

However, air bubbles are often generated in individual separated compartments in processes of liquid feeding, degassing, and the like.

When there is an air bubble in an individual separated compartment, there occurs a problem in that a fluorescence signal of the individual separated compartment cannot be successfully measured. In order to address this problem, in Japanese Patent Application Laid-Open No. 2017-78717, there is disclosed a technology in which two reflection mechanisms are held in a system, LED light is caused to pass over the individual separated compartment and detected by a detector, and presence or absence of an air bubble is determined based on an intensity of the LED light at that time. However, holding the reflection mechanisms in the system for the purpose of air bubble detection leads to enlargement of the system and increase in cost. In addition, various factors that cause deterioration in measurement accuracy include not only air bubbles but also seepage into a neighboring individual separated compartment due to poor isolation of an individual separated compartment, fluorescence intensity deterioration, an artifact due to a non-specific reaction, and an artifact derived from dust.

### SUMMARY

According to the present disclosure, there is provided an information processing system using an individual separated compartment for detecting a target through use of the individual separated compartment, the information processing system including: an image acquisition unit configured to acquire an image including, as an object, a plurality of individual separated compartments in which a target is includable; an exclusion region determination unit configured to set, based on the image, a characteristic value for determining an exclusion region to be excluded from among a plurality of regions of the image, and determine the exclusion region based on the characteristic value of the plurality of regions; and a calculation unit configured to calculate information relating to the target from an image of individual separated compartments included in each region for calculation obtained by excluding the exclusion region from the image.

Further features of the present disclosure will become apparent from the following description of embodiments with reference to the attached drawings.

### BRIEF DESCRIPTION OF THE DRAWINGS

FIG. 1 is an illustration of an information processing system according to an embodiment of the present disclosure.

FIG. 2 is a cross-sectional view of a well plate.

FIG. 3 shows an example of images in which an aggregate is an object.

FIG. 4 is a diagram for illustrating setting of regions.

FIG. 5 is an illustration of an example of a detection method according to the embodiment of the present disclosure.

FIG. 6 is an illustration of an example of a detection apparatus according to the embodiment of the present disclosure.

FIG. 7 is an illustration of a hardware configuration of the information processing system.

FIG. 8A shows an example of a bright-field image obtained in Example.

FIG. 8B shows an example of an individual separated compartment extraction mask image obtained in the Example.

FIG. 8C shows an example of a mask image obtained by extracting target-capturing substances in Example.

FIG. 8D shows an example of a target-capturing-substance-including individual separated compartment extraction mask image obtained in the Example.

FIG. 9 shows results of Example.

### DESCRIPTION OF THE EMBODIMENTS

An embodiment of the present disclosure is now described in detail with reference to the drawings. However, components described in the embodiment are merely an example. The technical scope of the present disclosure is defined by the appended claims, and is not limited by the embodiment to be described below.

According to one embodiment of the present disclosure, there is provided an information processing system using an individual separated compartment for detecting a target through use of the individual separated compartment, the information processing system including: an image acquisition unit configured to acquire an image including, as an object, a plurality of individual separated compartments in which a target is includable; an exclusion region determination unit configured to set, based on the image, a characteristic value for determining an exclusion region to be excluded from among a plurality of regions of the image, and determine the exclusion region based on the characteristic value of the plurality of regions; and a calculation unit configured to calculate information relating to the target from an image of individual separated compartments included in each region for calculation obtained by excluding the exclusion region from the image.

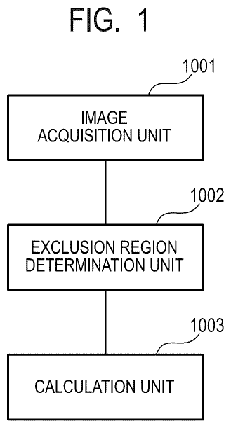

FIG. 1 is an illustration of the information processing system according to this embodiment. The information processing system according to this embodiment is an information processing system for detecting a target through use of an individual separated compartment, and includes an image acquisition unit, an exclusion region determination unit, and a calculation unit. The image acquisition unit 1001 acquires an image including, as an object, a plurality of individual separated compartments that can include a target. The exclusion region determination unit 1002 sets, based on the image, a characteristic value for determining an exclusion region to be excluded from among a plurality of regions of the image, and determines the exclusion region based on the characteristic value of the plurality of regions. The calculation unit 1003 calculates information relating to the target from an image of each individual separated compartment included in each region for calculation obtained by excluding the exclusion region from the image. It is preferred that the exclusion region determination unit acquire the characteristic value for each of the plurality of regions.

### <Individual Separated Compartment>

Preparation of a plurality of individual separated compartments that can include a target is described.

Each individual separated compartment refers to an independently separated compartment. A volume of the compartment is preferred to be minute, and the volume is preferred to be 0.1 fL or more and 1,000 fL or less. As preferred examples of the individual separated compartments, there can be mentioned liquid droplets and wells of a well plate. A subject including a plurality of individual separated compartments may be referred to as “aggregate.” For example, the well plate is an aggregate, and a liquid (which may include a container thereof) including a plurality of liquid droplets is an aggregate.

As each of the liquid droplets, a water-in-oil type emulsion (W/O emulsion) is preferred to be used.

Such liquid droplets can be prepared by a pumping method with an emulsification membrane.

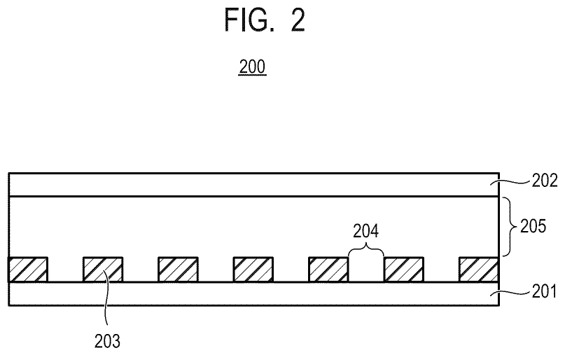

An example of the well of the well plate is illustrated in FIG. 2. Wells 204 are recesses for accommodating a solution, and are separated from each other by partition walls 203. The wells 204 can use a lower substrate 201 as bottom surfaces thereof, and a shape of a region surrounded by the bottom surface and side surfaces of each of the wells 204 may be, for example, a columnar shape or a prismatic shape. When the shape of each of the wells 204 is a columnar shape having a circular bottom surface, it is preferred that a diameter of the bottom surface of each of the wells 204 be 0.5 μm or more and 12 μm or less, and a depth of each of the wells 204 be 0.5 μm or more and 12 μm or less. In addition, it is further preferred that the diameter of the bottom surface of each of the wells 204 be 1 μm or more and 9 μm or less, and the depth of each of the wells 204 be 1 μm or more and 9 μm or less. It is preferred that an upper substrate 202 be opposed to openings of the wells 204 and top surfaces of the partition wall 203 across a space 205. The space 205 serves as a channel through which various liquids flow, and the various liquids can flow from an injection port portion (not shown) toward a discharge port portion. As the well plate, a commercially available material such as a Simoa disc may be used, or the well plate may be manufactured.

When a sample solution including a target is distributed to the individual separated compartments, the sample solution is apparently brought into a concentrated state, and it is possible to detect the target without performing an amplification step and shorten a time period for signal saturation. A volume per compartment of the individual separated compartments can be sufficiently reduced to set the target included in one compartment to one molecule or less, and it is possible to perform a digital assay for calculating a concentration of the target in the sample solution by counting the number of compartments from which signals are obtained.

The target may be any of various substances without limitation, and examples thereof can include a protein, a nucleic acid, a lipid, a sugar, a low-molecular-weight compound, an enzyme, a ligand, a receptor, an antibody, an antigen, a cytokine, a hormone, and a membrane protein.

The individual separated compartments can include a detection reagent, and a sample solution including a target can include a detection reagent. The detection reagent is preferred to exhibit a signal through interaction with the target. Any publicly known substance can be used as the detection reagent without limitation. For example, when the target is a nucleic acid and a CRISPR-Cas system is used, it is possible to use, as the detection reagent, an effector protein, crRNA to be bound to a target nucleic acid, and a reporter molecule. That is, the crRNA is bound to the target nucleic acid to activate the effector protein, and the reporter molecule is modified by the activated effector protein to generate fluorescence as a signal. When the target is a nucleic acid, without limitation to the above-mentioned system, it is possible to use various probes that each exhibit a signal in accordance with presence or an amount of the nucleic acid of the target.

Examples of the detection reagent for a case in which the target is a protein can include an antibody, a modified antibody, a ligand, and an aptamer, and those can be labeled with a fluorescent dye, an enzyme, or the like to generate a signal. In another case, when the target is an enzyme, an enzyme substrate can be used as the detection reagent. The enzyme substrate may be labeled with a fluorescent dye and modified by the substrate to generate fluorescence as a signal.

When the target per individual separated compartment is set to one molecule or less, an effective digital assay is enabled. In another case, in a case of using a target-capturing substance, when the number of targets per target-capturing substance is set to one molecule or less, the same effect is obtained, thereby enabling a digital assay.

Examples of the target-capturing substance include a particle. The particle may be bound with an antibody or the like in order to capture the target. Examples of the particle include a polymer resin (styrene resin, acrylic resin, or the like) particle, a silica particle, an agarose carrier resin particle, a metal particle, a latex particle, and a magnetic particle. The use of the target-capturing substance enables the target to be separated through use of centrifugation or magnetism. It is preferred to allow use of a particle having a particle diameter of 1 μm or more and 10 μm or less.

The distribution to the individual separated compartments is described.

Referring back to FIG. 2, a case in which the well plate is used as the aggregate and the well is used as the individual separated compartment is described. An aggregate 200 (in this case, well plate) is left to stand under reduced pressure to degas the space 205. Specifically, it is preferred to leave the well plate in a vacuum desiccator of 0.1 atm for a predetermined time period. Through degassing, the air in the wells 204 is removed, to thereby be able to efficiently fill the wells 204 with the reaction liquid. A degassing time period is not particularly limited, and can be freely set. The reaction liquid filling method is not limited to a method based on the degassing. Next, a hydrophobic solvent is fed into the space 205, and the space 205 is sealed. That is, the reaction liquid present in the space 205 above the wells 204 is replaced with the hydrophobic solvent. Examples to be used as the hydrophobic solvent can include a fluorine-based oil, a saturated aliphatic hydrocarbon, an unsaturated aliphatic hydrocarbon, an aromatic hydrocarbon, and a silicone oil. Examples of the fluorine-based oil can include Fluorinert, AsahiKlin AE-3000 (manufactured by AGC Inc.), and Fomblin (manufactured by Solvay S.A.). Examples of the saturated hydrocarbon can include Isopar (manufactured by Exxon Mobil Corporation) and a mineral oil.

When liquid droplets are used as the individual separated compartments, the liquid droplets can be prepared by a pumping method with an SPG emulsification membrane while a sample solution is used as a dispersed phase and an aliphatic hydrocarbon solvent including a surfactant is used as a continuous phase.

Signal generation is described. The individual separated compartments to which the sample solution including the target has been distributed perform signal generation, as appropriate, in order to generate a signal.

For example, in the case of using a CRISPR-Cas system described above, incubation is performed at 37° C. Through this incubation, a trans-cleavage reaction of CRISPR-Cas progresses, and fluorescence derived from a fluorescent substance possessed by the reporter molecule is generated. In the example of using an enzyme as the target, the reaction is progressed at a temperature optimal for the enzyme, to thereby be able to perform the signal generation.

### <Image Acquisition Unit>

Next, the image acquisition unit is described. The image acquisition unit acquires an image including a plurality of individual separated compartments as an object. The term “image” includes all pieces of information included in an image, for example, includes all kinds of information such as a brightness, a color, and a tone for each set of coordinates, and the image acquisition unit can acquire required information among all those kinds of information. The image may be obtained through extraction. In the image, an entire aggregate, that is, an entire well plate or an entire liquid including liquid droplets included in the container may be used as the object, or part of the aggregate, that is, part of the well plate or part of the liquid including liquid droplets may be used as the object. The image is preferred to include at least any one of a bright-field image or an image that allows acquisition of information on a signal indicating presence of a target. The image that allows the acquisition of the information on the signal indicating the presence of the target can be exemplified by a fluorescent image. Any image acquisition unit that can acquire an image can be employed without limitation, and an image pickup apparatus such as a microscope or a CCD camera integrated with the information processing system may be employed as the image acquisition unit, or a device that acquires information on a picked-up image by being connected to such an image pickup apparatus may be employed.

The image includes wells or particles in the individual separated compartments. The image acquisition unit is not required to acquire an image by performing photographing only once, and may perform photographing a plurality of times to combine the obtained images as one image. When the individual separated compartments are wells, one image can include an entire image of one aggregate, but one image is not always required to correspond to one aggregate, and one image may include a plurality of aggregates or may include only part of the aggregate. For example, in a commercially available microscope for picking up an image of a well plate, there is known a microscope in which an image of about 6×10³ wells is picked up for one shot, this image pickup is repeated for 100 shots, and those shots are linked together to form an image corresponding to 6×10⁵ wells.

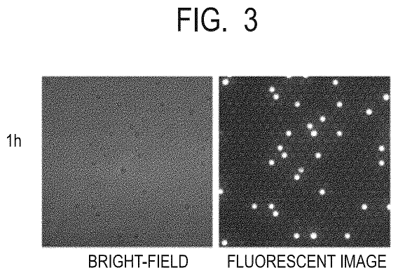

FIG. 3 shows an example of images including an aggregate as an object. FIG. 3 shows images obtained by picking up, by a fluorescent microscope, images of a plurality of individual separated compartments subjected to detection by the CRISPR-Cas system with a nucleic acid used as a target through use of a well plate. Particles were used as target-capturing substances. A bright-field image is shown on the left, and a fluorescent image is shown on the right. Particles can be confirmed in the bright-field image of FIG. 3. In the fluorescent image, fluorescence derived from a detection reagent can be confirmed.

The information processing system according to this embodiment may include an extraction unit. The extraction unit creates an extraction mask image. Through use of any one of the bright-field image or the image that allows the acquisition of the information on the signal indicating the presence of the target, it is possible to create an individual separated compartment extraction mask image in which each individual separated compartment has been extracted and/or a target-capturing-substance-including individual separated compartment extraction mask image in which individual separated compartments including target-capturing substances have been extracted (e.g., an image in which wells containing particles have been extracted).

As a method of creating the extraction mask image, the following methods are conceivable. For example, when the aggregate is a well plate, the wells being individual separated compartments are regularly arranged, and hence a method of creating a template in advance and adjusting the translation direction and the angle by template matching or the like is conceivable. A method of emphasizing the outer periphery of the individual separated compartment through edge detection using a Sobel filter or the like and performing circle detection through a Hough transform or the like is also conceivable.

The target-capturing-substance-including individual separated compartment extraction mask image can be obtained by extracting a mask image in which target-capturing substances have been extracted and superimposing the extracted mask image on the individual separated compartment extraction mask image.

### <Exclusion Region Determination Unit>

The exclusion region determination unit divides the acquired image into a plurality of regions, and determines the exclusion region that is not to be used by the calculation unit among the plurality of regions. The exclusion region refers to a region including, for example, an air bubble or dust in the aggregate of individual separated compartments, the region being feared to be erroneously recognized as apparently having a signal emitted therefrom in the image. The exclusion region determination unit sets a characteristic value appropriate for determining the exclusion region, and determines the exclusion region based on the characteristic value of each region.

The acquired image is assumed to be formed of a plurality of regions, and is subjected to subsequent information processing. The image is preferred to include 10 or more and 1,000 or less regions, each region is preferred to include 100 or more and 100,000 or less individual separated compartments, and one region is further preferred to include 500 or more individual separated compartments. The plurality of regions of the image are preferred to have mutually equivalent areas.

The plurality of regions are preferred to have overlapping portions that overlap with each other. In addition, the image is preferred to be covered with all the plurality of regions. It is preferred to determine the area of each region so that 100 or more individual separated compartments or target-capturing substances are present in each region in view of accuracy of analysis described later. When the image is a combination of a plurality of shots, each of the shots may be set as one region.

Examples of the characteristic value can include the following values. A positive individual separated compartment represents an individual separated compartment indicating that the individual separated compartment includes a target, and a negative individual separated compartment represents an individual separated compartment indicating that the individual separated compartment does not include a target.

Which of the positive individual separated compartment and the negative individual separated compartment is to be set can be determined by, for example, providing a threshold value for information on an intensity of a signal (signal intensity or brightness) in the image that allows the acquisition of the information on the signal indicating the presence of the target. For example, the threshold value may be automatically determined from the intensities of signals of the respective individual separated compartments by Otsu's method or the like, or an aggregate that does not include a target may be used to determine the threshold value from variations in signal intensity thereof. The threshold value may be determined based on a signal intensity of the individual separated compartment that does not include a target-capturing substance. A signal that does not exceed the threshold value may be considered as a background.

The examples of the characteristic value can include the number of positive individual separated compartments, a ratio of the number of positive individual separated compartments to the number of individual separated compartments, an average value of brightness of the individual separated compartments, a median value of brightness of the individual separated compartments, a maximum value of brightness of the individual separated compartments, and a minimum value of brightness of the individual separated compartments. The brightness is a brightness in the bright-field image, and refers to, in the image that allows the acquisition of the information on the signal indicating the presence of the target, an intensity (e.g., fluorescence intensity) of the signal indicating the presence of the target.

In the case of using the target-capturing substance for capturing a target, the examples of the characteristic value can further include an average value of brightness of the individual separated compartments that do not include target-capturing substances, a median value of brightness of the individual separated compartments that do not include target-capturing substances, a maximum value of brightness of the individual separated compartments that do not include target-capturing substances, a minimum value of brightness of the individual separated compartments that do not include target-capturing substances, a standard deviation of brightness of the individual separated compartments that do not include target-capturing substances, an average value of brightness of the individual separated compartments that include target-capturing substances, a median value of brightness of the individual separated compartments that include target-capturing substances, a maximum value of brightness of the individual separated compartments that include target-capturing substances, a minimum value of brightness of the individual separated compartments that include target-capturing substances, a standard deviation of brightness of the individual separated compartments that include target-capturing substances, the number of target-capturing substances, a value obtained by dividing the number of positive individual separated compartments by the number of individual separated compartments that include target-capturing substances, and a target-capturing substance filling rate.

The value obtained by dividing the number of positive individual separated compartments by the number of individual separated compartments that include target-capturing substances is determined as follows. That is, the image that allows the acquisition of the information on the signal indicating the presence of the target, the individual separated compartment extraction mask image, and the target-capturing-substance-including individual separated compartment extraction mask image are used to calculate the brightness (signal intensity) of each individual separated compartment, and it is possible to identify individual separated compartments having target-capturing substances present therein and corresponding to positive individual separated compartments. The target-capturing substance filling rate represents a value obtained by dividing the number of individual separated compartments that include target-capturing substances by the number of individual separated compartments.

A preferred example of the characteristic value is an average positive rate (APR). The APR is defined as the ratio of the number of positive individual separated compartments to the number of individual separated compartments when the target-capturing substances are not used, and is set as the value obtained by dividing the number of positive individual separated compartments by the number of individual separated compartments that include target-capturing substances when the target-capturing substances such as immobilized particles are used.

The exclusion region determination unit determines a threshold value for the characteristic value through statistical processing from the characteristic value of each region and the characteristic value of the plurality of regions, to thereby determine the exclusion region.

When the characteristic value of each region is obtained as Vt, the average of the characteristic value of the plurality of regions is obtained as μ_{V}, and the standard deviation of the characteristic value of the plurality of regions is obtained as δ_{V}, a function derived from those values is used to determine the threshold value, to thereby be able to determine the exclusion region based on the determined threshold value. For example, when μ±3σ is used as the threshold value, each of a region that satisfies Vt<μ−3σ and a region that satisfies Vt>μ+3σ can be determined as the exclusion region. In this case, the threshold value is exemplified by μ±3σ, but it is possible to set an appropriate threshold value such as 1σ, 2σ, or 4σ in place of 3σ.

In an assay using the individual separated compartments which is a digital assay, the characteristic value is assumed to cause no variation among a plurality of regions. Thus, a region in which the characteristic value does not fall within μ±3σ is considered to have some abnormality. Examples of the abnormality mainly include generation of air bubbles, poor isolation, adhesion of dust, poor liquid feeding, and a non-specific reaction.

When the APR is set as the characteristic value, an average value (μ_{APR}) of the APR of the plurality of regions and a standard deviation (δ_{APR}) of the APR of the plurality of regions can be determined in accordance with the following expressions. In the following expressions, “t” represents the number of regions.

$${μ}_{APR} = \frac{{\sum }_{n = 1}^{t} {APR}_{n}}{t} \\ {σ}_{APR} = \sqrt{\frac{{\sum }_{n = 1}^{t} {( {μ}_{APR} - {APR}_{n} )}^{2}}{t - 1}}$$

The value of the characteristic value that is clearly abnormal distorts the values of the average value and the standard deviation, and thus may be excluded when the average value and the standard deviation are calculated. In that case, it is required to subtract the number of excluded values from “t” described above.

The threshold value for the characteristic value may be set in advance by a user. For example, when the target-capturing substance filling rate is used, the threshold values may be set to 4% and 40% to determine, as the exclusion region, each of a region in which the target-capturing substance filling rate is less than 4% and a region in which the target-capturing substance filling rate exceeds 40%.

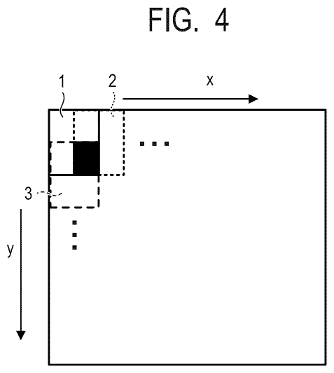

In regard to the setting of regions, an example of providing overlapping parts is described with reference to FIG. 4. In FIG. 4, half of the area is set to overlap, but a size of the overlapping area is freely set. When regions are set so that half of each area overlaps, the total number of regions is (2j−1)×(2k−1). In this case, “j” and “k” are the numbers of regions in the “x” direction and the “y” direction that are obtained on the assumption that regions are set without overlaps. All the regions are desired to have the same area. When the regions are set so as to overlap with each other in this manner, it is possible to finely detect regions to be excluded at a time of calculation without reducing the area of each region.

A solid black part (minimum region) illustrated in FIG. 4 is a part in which a region 1 at the upper left corner, a region 2 (indicated by the dotted line) moved by half in the “x” direction, and a region 3 (indicated by the broken line) moved in the “y” direction overlap each other. In order for this solid black region to be a true exclusion region, it is required to recognize all the region 1, the region 2, and the region 3 as the exclusion regions. When any one of the region 1, the region 2, or the region 3 is not recognized as the exclusion region, the solid black region is the region for calculation rather than the exclusion region. This processing is performed for all the minimum regions, to thereby be able to identify a true abnormal region.

### <Calculation Unit>

The calculation unit can calculate the information relating to the target from an image of individual separated compartments included in each region for calculation obtained by excluding the exclusion region from the image. In this case, the information relating to the target may be calculated based on the characteristic values of the respective regions for calculation. That is, information on true characteristic values can be obtained from the characteristic values only of the regions for calculation, and the information relating to the target can be calculated therefrom.

For example, APR(P(k)) can be calculated from the APR of each region for calculation. When the number of targets included in the sample is large, one individual separated compartment may include two or more targets. Thus, the number of targets may fail to match the number of individual separated compartments generating signals. For the above-mentioned reason, it is preferred to calculate the concentration of the target through calculation that takes the Poisson distribution into consideration. In the Poisson distribution, when the average number of targets per individual separated compartment is set as λ, a ratio P(k) of the wells generating signals can be expressed by Expression (3).

$$P ( k \vert λ ) = ( {λ}^{k} / k ! ) {e}^{- 1} ( k = 0 , 1 , 2 , … ) \qquad ( 3 )$$

From the number of individual separated compartments generating signals, P(k) can be determined and the number k of targets can be calculated. The concentration can be calculated by comparing the calculated λ with a calibration curve or the like created in advance. Thus, through use of Expression (3), the concentration of the target can be calculated from the number of individual separated compartments from which signals have been detected among all the individual separated compartments in the image.

With the information processing system according to this embodiment, a region that causes deterioration in measurement accuracy is appropriately excluded at the time of calculation, and hence it is possible to improve the measurement accuracy. This improves measurement stability in extremely low concentration measurement, and hence it is possible to extend a detection lower limit.

As another embodiment, the present disclosure provides the following detection method.

The detection method is a detection method using an individual separated compartment for detecting a target through use of the individual separated compartment, the detection method including: an image acquisition step of acquiring an image including, as an object, a plurality of individual separated compartments in which a target is includable; a characteristic value setting step of setting, based on the image, a characteristic value for determining an exclusion region to be excluded from among a plurality of regions of the image; an exclusion region determination step of determining the exclusion region based on the characteristic value of the plurality of regions; and a calculation step of calculating information relating to the target from an image of individual separated compartments included in each region for calculation obtained by excluding the exclusion region from the image.

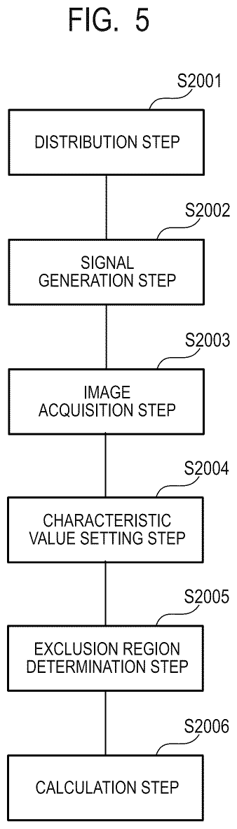

Referring to FIG. 5, the detection method according to this embodiment is described. The detection method according to this embodiment includes an image acquisition step S2003, a characteristic value setting step S2004, an exclusion region determination step S2005, and a calculation step S2006, and can further include a distribution step S2001 and a signal generation step S2002. Each step is as described above.

Further, the present disclosure includes, as one embodiment, a non-transitory storage medium storing a program for executing the above-mentioned method.

As still another embodiment, the present disclosure provides the following detection apparatus.

The detection apparatus is a detection apparatus including: a placer configured to place an aggregate including individual separated compartments; an image acquisition unit configured to acquire images by picking up a plurality of images of the individual separated compartments; and an information processor, wherein the information processor includes: a characteristic value setting unit configured to set, based on the image, a characteristic value for determining an exclusion region to be excluded from among a plurality of regions of the image; an exclusion region determination unit configured to determine the exclusion region based on the characteristic value of the plurality of regions; and a calculation unit configured to calculate information relating to the target from an image of individual separated compartments included in each region for calculation obtained by excluding the exclusion region from the image.

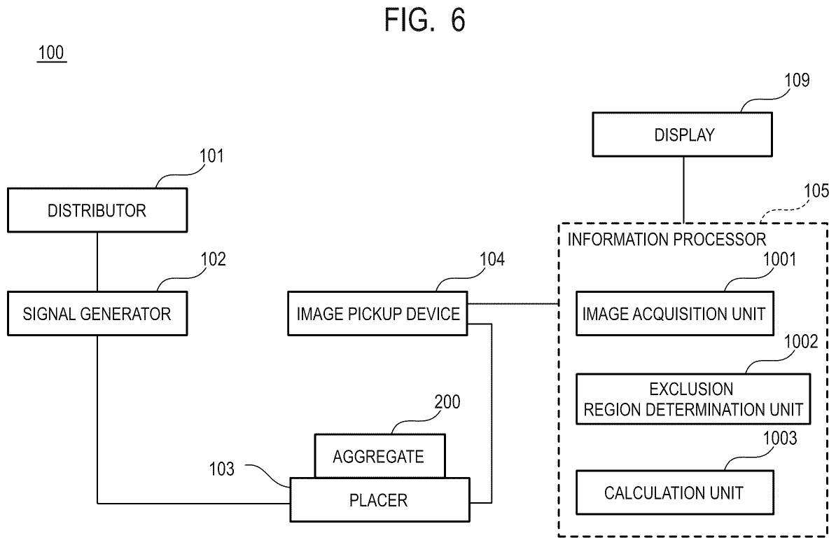

Referring to FIG. 6, the detection apparatus according to this embodiment is described.

The apparatus according to this embodiment includes a placer 103, an image pickup device 104, and an information processor 105. The information processor 105 includes the information processing system described above, that is, includes the image acquisition unit 1001 that acquires an image including, as an object, a plurality of individual separated compartments that can include a target, the exclusion region determination unit 1002 that sets, based on the image, a characteristic value for determining an exclusion region to be excluded from among a plurality of regions of the image and determines the exclusion region based on the characteristic value of the plurality of regions, and the calculation unit 1003 that calculates information relating to the target from an image of individual separated compartments included in each region for calculation obtained by excluding the exclusion region from the image.

The placer 103 places the aggregate 200. The placer can include a fixing portion adapted to the aggregate for placing the aggregate 200 thereon. The image pickup device 104 picks up an image including, as an object, a plurality of individual separated compartments included in the aggregate. The image pickup device is connected to the information processor 105.

The detection apparatus can further include a distributor 101, a signal generator 102, and a display 109. The distributor 101 can include, for example, a robot arm, a pipette, a device for degassing, and a pumping device for distributing a sample solution including a target to the individual separated compartments. The signal generator includes, for example, an incubator, a stirrer, and a penetration device so that a signal is generated from each of the individual separated compartments to which the sample solution including the target is distributed. The display includes a monitor of a personal computer.

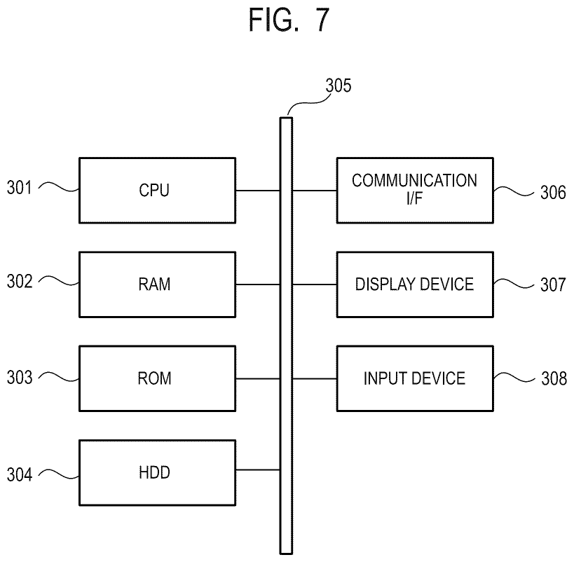

A hardware configuration of the information processor 105 in this embodiment is described with reference to FIG. 7. The information processor 105 has functions of a computer. For example, the information processing system may be configured unitarily with a desktop personal computer (PC), a laptop PC, a tablet PC, a smartphone, or the like. The information processor 105 may have functions of controlling operations of the distributor 101, the signal generator 102, and the image pickup device 104 in accordance with a predetermined program.

The information processor 105 includes, in order to implement functions as a computer that performs arithmetic operation and storage, a central processing unit (CPU) 301, a random-access memory (RAM) 302, a read-only memory (ROM) 303, and a hard disk drive (HDD) 304. The information processor 105 also includes a communication interface (I/F) 306, a display device 307, and an input device 308. The CPU 301, the RAM 302, the ROM 303, the HDD 304, the communication I/F 306, the display device 307, and the input device 308 are connected to each other via a bus 305. The display device 307 and the input device 308 may be connected to the bus 305 via a drive device (not shown) for driving those devices.

In FIG. 7, the various components forming the information processor 105 are illustrated as an integrated device, but part of the functions of those components may be implemented by an external device. For example, the display device 307 and the input device 308 may be external devices different from the components implementing the functions of the computer including the CPU 301 and the like.

The CPU 301 performs predetermined operations in accordance with programs stored in, for example, the RAM 302 and the HDD 304, and also has a function of controlling each component of the information processor 105. The RAM 302 is built from a volatile storage medium, and provides a temporary memory area required for the operations of the CPU 301. The ROM 303 is built from a non-volatile storage medium, and stores required information such as programs to be used for the operations of the information processor 105. The HDD 304 is a storage device which is built from a non-volatile storage medium, and which stores information on, for example, the number of individual separated compartments and positions thereof and fluorescence intensities.

The communication I/F 306 is a communication interface based on a standard, such as Wi-Fi (trademark) or 4G, and is a module for communicating to and from another device. The display device 307 is, for example, a liquid crystal display or an organic light emitting diode (OLED) display, and is used for displaying moving images, still images, characters, and the like. The input device 308 is, for example, a button, a touch panel, a keyboard, or a pointing device, and is used by a user to operate the information processor 105. The display device 307 and the input device 308 may be integrally formed as a touch panel.

The hardware configuration illustrated in FIG. 7 is an example, and devices other than the illustrated devices may be added, or part of the illustrated devices may be omitted. In addition, part of the devices may be substituted with another device having the same function. Further, part of the functions may be provided by another device via a network, and the functions for implementing the embodiments may be shared and implemented by a plurality of devices. For example, the HDD 304 may be substituted with a solid state drive (SSD) using a semiconductor element such as a flash memory, or may be substituted with cloud storage.

The CPU 301 implements functions of the image acquisition unit 1001, the exclusion region determination unit 1002, and the calculation unit 1003 by loading the program stored in the ROM 303 or another place onto the RAM 302 and executing the program. The CPU 301 also implements a function of the display 109 by controlling the display device 307. The CPU 301 implements a function of a storage as well by controlling the HDD 304.

### Example

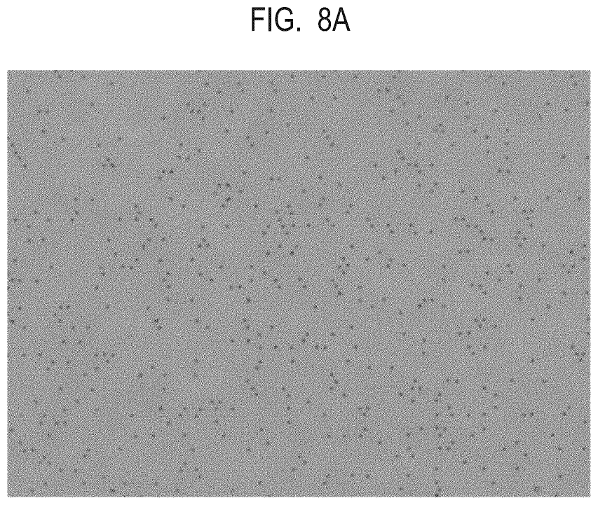

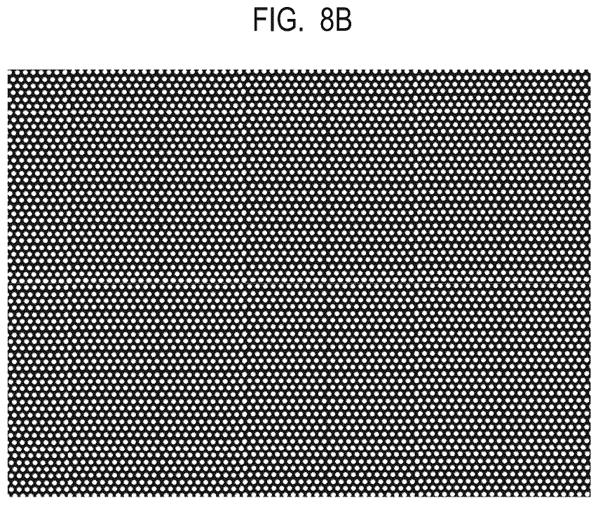

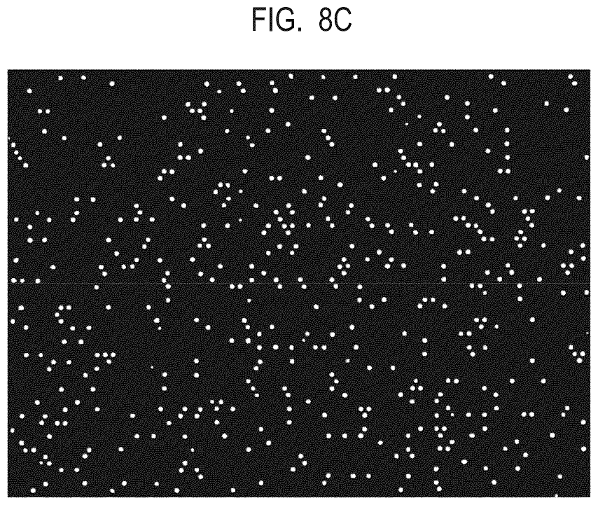

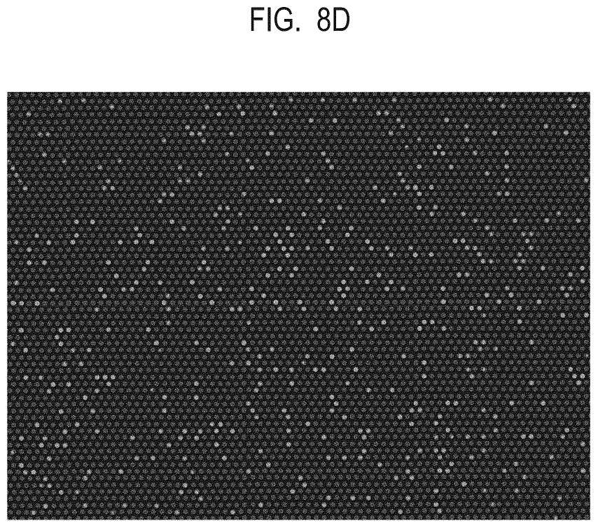

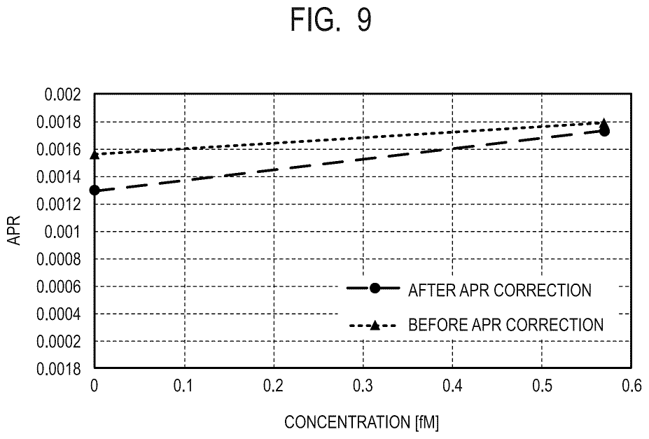

FIG. 8A to FIG. 8D and FIG. 9 show examples of images obtained in Example. FIG. 8A is a bright-field image, FIG. 8B is an individual separated compartment extraction mask image, FIG. 8C is a mask image obtained by extracting target-capturing substances, and FIG. 8D is a target-capturing-substance-including individual separated compartment extraction mask image obtained by superimposing those images.

In this Example, a nucleic acid was used as the target, and the concentrations were 0 fM and 0.57 fM. Fluorescence derived from a fluorescent substance possessed by a reporter molecule was set as the signal. In regard to the characteristic value, the APR was used as the characteristic value, that is, the APR was set as the ratio of the number of positive individual separated compartments to the number of individual separated compartments when the target-capturing substances were not used, and was set as the value obtained by dividing the number of positive individual separated compartments by the number of individual separated compartments including target-capturing substances when the target-capturing substances were used.

Results thereof are shown in FIG. 9. When the information processing system according to the present disclosure was not applied, a difference in measurement results between 0 fM and 0.57 fM was small. Meanwhile, when the information processing system according to the present disclosure was applied, erroneous extraction of an air bubble region and erroneous extraction of a non-specific reaction were successfully eliminated, thereby being able to clearly distinguish between 0 fM and 0.57 fM.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to perform detection using the individual separated compartment with high accuracy.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-005486, filed Jan. 17, 2023, which is hereby incorporated by reference herein in its entirety.

What is claimed is:

1. An information processing system using an individual separated compartment for detecting a target through use of the individual separated compartment, the information processing system comprising:
an image acquisition unit configured to acquire an image including, as an object, a plurality of individual separated compartments in which a target is includable;
an exclusion region determination unit configured to set, based on the image, a characteristic value for determining an exclusion region to be excluded from among a plurality of regions of the image, and determine the exclusion region based on the characteristic value of the plurality of regions; and
a calculation unit configured to calculate information relating to the target from an image of individual separated compartments included in each region for calculation obtained by excluding the exclusion region from the image.

2. The information processing system according to claim 1, wherein the exclusion region determination unit is configured to acquire the characteristic value for each of the plurality of regions.

3. The information processing system according to claim 1, wherein the characteristic value comprises any one selected from a group consisting of:
a number of positive individual separated compartments;
a ratio of the number of positive individual separated compartments to the number of individual separated compartments;
an average value of brightness of the individual separated compartments;
a median value of brightness of the individual separated compartments;
a maximum value of brightness of the individual separated compartments; and
a minimum value of brightness of the individual separated compartments,
where the positive individual separated compartment represents an individual separated compartment indicating that the individual separated compartment includes a target and a negative individual separated compartment represents an individual separated compartment indicating that the individual separated compartment does not include a target.

4. The information processing system according to claim 1,
wherein the information processing system is configured to use a target-capturing substance for capturing a target, and
wherein the characteristic value comprises any one selected from a group consisting of:
a number of positive individual separated compartments;
a ratio of the number of positive individual separated compartments to the number of individual separated compartments that include target-capturing substances;
an average value of brightness of the individual separated compartments;
a median value of brightness of the individual separated compartments;
a maximum value of brightness of the individual separated compartments;
a minimum value of brightness of the individual separated compartments;
an average value of brightness of the individual separated compartments that do not include target-capturing substances;
a median value of brightness of the individual separated compartments that do not include target-capturing substances;
a maximum value of brightness of the individual separated compartments that do not include target-capturing substances;
a minimum value of brightness of the individual separated compartments that do not include target-capturing substances;
a standard deviation of brightness of the individual separated compartments that do not include target-capturing substances;
an average value of brightness of the individual separated compartments that include target-capturing substances;
a median value of brightness of the individual separated compartments that include target-capturing substances;
a maximum value of brightness of the individual separated compartments that include target-capturing substances;
a minimum value of brightness of the individual separated compartments that include target-capturing substances;
a standard deviation of brightness of the individual separated compartments that include target-capturing substances;
a number of target-capturing substances;
a value obtained by dividing the number of positive individual separated compartments by the number of individual separated compartments that include target-capturing substances; and
a target-capturing substance filling rate,
where the positive individual separated compartment represents an individual separated compartment indicating that the individual separated compartment includes a target-capturing substance and includes a target, a negative individual separated compartment represents an individual separated compartment indicating that the individual separated compartment includes a target-capturing substance and does not include a target, and the target-capturing substance filling rate represents a value obtained by dividing the number of individual separated compartments that include target-capturing substances by the number of individual separated compartments.

5. The information processing system according to claim 1, wherein the exclusion region determination unit is configured to determine the exclusion region through statistical processing from the characteristic value of each of the plurality of regions and the characteristic value of the plurality of regions.

6. The information processing system according to claim 1, wherein the exclusion region determination unit is configured to determine the exclusion region based on Vt, μ_{V}, and δ_{V}, where Vt represents the characteristic value of each of the plurality of regions, μ_{V} represents an average of the characteristic value of the plurality of regions, and δ_{V} represents a standard deviation of the characteristic value of the plurality of regions.

7. The information processing system according to claim 1, wherein the exclusion region determination unit is configured to determine, as the exclusion region, each of a region that satisfies Vt<μ−3σ and a region that satisfies Vt>μ+3σ, where Vt represents the characteristic value of each of the plurality of regions, μ_{V} represents an average of the characteristic value of the plurality of regions, and δ_{V} represents a standard deviation of the characteristic value of the plurality of regions.

8. The information processing system according to claim 4, wherein the exclusion region determination unit is configured to set the characteristic value to the target-capturing substance filling rate and determine, as the exclusion region, each of a region in which the target-capturing substance filling rate is less than 4% and a region in which the target-capturing substance filling rate exceeds 40%.

9. The information processing system according to claim 4, wherein the target-capturing substance comprises a magnetic particle, wherein the particle has a particle diameter of 1 μm or more and 10 μm or less.

10. The information processing system according to claim 1, wherein the image comprises at least any one of a bright-field image or a fluorescent image.

11. The information processing system according to claim 1, wherein the image includes 10 or more and 1,000 or less regions among the plurality of regions.

12. The information processing system according to claim 1, wherein the plurality of regions of the image have mutually equivalent areas.

13. The information processing system according to claim 1, wherein the plurality of regions of the image have overlapping portions that overlap with each other.

14. The information processing system according to claim 1, wherein the image is covered with all the plurality of regions of the image.

15. The information processing system according to claim 1, wherein the image is inhibited from being covered with all the plurality of regions of the image.

16. The information processing system according to claim 1, wherein each of the plurality of regions includes 100 or more and 100,000 or less individual separated compartments.

17. The information processing system according to claim 1, wherein the individual separated compartment comprises one of a well or a liquid droplet.

18. The information processing system according to claim 1, wherein the individual separated compartment has a volume of 0.1 fL or more and 1,000 fL or less.

19. A detection method using an individual separated compartment for detecting a target through use of the individual separated compartment, the detection method comprising:
an image acquisition step of acquiring an image including, as an object, a plurality of individual separated compartments in which a target is includable;
a characteristic value setting step of setting, based on the image, a characteristic value for determining an exclusion region to be excluded from among a plurality of regions of the image;
an exclusion region determination step of determining the exclusion region based on the characteristic value of the plurality of regions; and
a calculation step of calculating information relating to the target from an image of individual separated compartments included in each region for calculation obtained by excluding the exclusion region from the image.

20. A non-transitory storage medium storing a program for executing the detection method of claim 19.
